(19) United States
(12) Patent Application Publication
(10) Pub. No.: US 2007/0184841 A1
(43) Pub. Date: Aug. 9, 2007

(54) Optical distributed network system using multi input multi output

(75) Inventors: Do-In Choi, Yongin-si (KR); Seong-Taek Hwang, Pyeongtaek-si (KR); Yun-Je Oh, Yongin-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/606,428

(22) Filed: Nov. 30, 2006

(30) Foreign Application Priority Data
Feb. 9, 2006 (KR) 12606/2006

(51) Int. Cl. H04Q 7/20

(52) U.S. Cl. 455/444

(57) ABSTRACT

Provided is a system for communicating between a base station transceiver subsystem and radio access units in a wireless communication system. The system includes a data path switch for switching a signal received from a base station controller, to a predetermined picocell, a micro cell HD controller and a picocell HD controller for detecting header information of the received signal, and controlling the data path switch, a picocell power meter for receiving a signal strength from a mobile terminal, and performing a power control, a modem for processing and transmitting the signal to an optical transceiver, and processing and transmitting a signal received from the optical transceiver to the data path switch and an optical transceiving unit for receiving and converting an electric signal into an optical signal, and receiving and converting an optical signal into an electric signal.

### CLAIM OF PRIORITY

This application claims the benefit of the earlier filing date, under 35 U.S.C. § 119, to that patent application entitled “Optical Distributed Network System Using Multi Input Multi Output” filed in the Korean Intellectual Property Office on Feb. 9, 2006 and assigned Serial No. 2006-12606, the contents of which are incorporated herein by reference.

### BACKGROUND OF THE INVENTION

1. Field of the Invention

The present invention relates generally to an optical distributed network system, and in particular, to an optical distributed network system using multi input multi output (MIMO) technology.

2. Description of the Related Art

Since the late 1970s when U.S. developed a cellular mobile communication system, Korea begin to provide a voice communication service by an advanced mobile phone service (AMPS) method that is based on an analogous 1^{st} generation (1G) mobile communication system. After that, in the middle 1990s, a code division multiple access (CDMA) system is commonly used as a 2^{nd} generation (2G) mobile communication system, and provides voice and low-rate data services.

International mobile telecommunication-2000 (IMT-2000), which is a 3^{rd} generation (3G) mobile communication system began in the late 1990s with the object of improved radio multimedia service, global roaming, and high-rate data service. The 3G mobile communication system is now s commonly used and is providing services presently. In particular, the 3^{rd} generation mobile communication system has been developed to transmit data at a higher rate as an amount of service data of the mobile communication system rapidly increases.

As the 3^{rd} generation mobile communication system begins to become more commonly implemented, attention is being transferred to a beyond 3^{rd} generation (B3G) or 4^{th} generation (4G) mobile communication system. The B3G or 4^{th} generation mobile communication systems are being standardized to provide an effective association and an integral service of a wire communication network and a wireless communication network, and not merely be associated with a simple wireless communication service like earlier generation mobile communication systems.

Accordingly, research in the wireless communication network is being performed to allow for transmitting large capacity data that are coming close to a capacity of the wire communication network. For this, a mobile communication system using multi input multi output (MIMO) technology is in the spotlight.

In general, the MIMO employs a multi transmission antenna and a multi reception antenna instead of one transmission antenna and one reception antenna, thereby improving an efficiency of data transmission. The MIMO significantly improves the data transmission efficiency, by transmitting and receiving several signals using several antennas substantially at the same time. Thus, it has an advantage of transmitting much more data than in the existing mobile communication system without increasing the bandwidth.

There is a great promise in which the carrier frequency for transmitting data is set to a band higher than an existing frequency of 5 GHz. The prospect is that a cell radius would be gradually reduced to keep a high data rate and the same capacity as an existing capacity according to a free space propagation model. Thus, a distributed network system based on a picocell of about one hundred meter seems to be required.

A conventional method for executing the distributed network system on a per-picocell basis is a method using an optical relay and a method using a multi hop technology.

The multi hop technology, a technology recently proposed for constructing a picocell having many cellular systems, can widen a service boundary of a cell without installation of a separate wire line. However, the multi hop technology has a drawback in that of frequency interference and thus, is limited in constructing and managing the cell.

However, the method using the optical relay has an advantage in that it is free from propagation (frequency) interference in managing the picocell.

FIG. 1 illustrates a construction of the distributed network system using an optical relay.

Referring to FIG. 1, the distributed network system includes a base station transceiver subsystem (BTS) 101, a base station controller (BSC) 102, a base station (BS) 103, and a radio access unit (RAU) 104.

In a detailed description of the distributed network system using the optical relay, the base station transceiver subsystem 101 performs the function of radio access with a mobile terminal (MT) (not shown), and the function of wire and radio access between the mobile terminal and the base station controller 102.

The base station controller 102 is positioned between the base station 103 and a mobile services switching center (not shown), and manages and controls the base station transceiver subsystem(s) 101 and the base station 103.

The base station 103 connects with the base station transceiver subsystem 101. The base station 103 receives a signal from the mobile terminal provided within its managing picocell, over a wireless channel, and transmits the received signal to the mobile services switching center. Similarly, the base station 103 transmits a signal from the mobile services switching center, to the mobile terminal over the wireless channel.

In general, in the distributed network system using the optical relay, a large area is divided into a plurality of smaller areas, referred to as picocells, for the effective management of the wireless channel. The distributed network system performs wireless communication with the mobile terminal through the base station 103 provided in each picocell. The picocell defines a wireless coverage area established by the base station 103 positioned in each picocell. Similarly, each picocell defines a related wireless coverage area established by a corresponding base station 103 positioned within the picocell.

The radio access units 104 connect with the base station transceiver subsystem 101, and form the picocells around the corresponding base station 103. The base station 103 and the mobile terminal(s) perform the wireless communication with each other using the picocells formed by the radio access units 104. While moving within the picocell(s), the mobile terminal measures a signal strength of each picocell, and selects the most relevant picocell for communication.

The distributed network system using the MIMO technology and on a per-picocell basis is a kernel technology of the B3G or 4^{th} generation mobile communication system.

However, the MIMO has been much researched, but a research for a way for applying the technology to the optical distributed radio system is not readily available. Thus, a research for the optical distributed radio system using the MIMO having a great efficiency is needed in the industry.

### SUMMARY OF THE INVENTION

It is, therefore, an object of the present invention to provide a structure corresponding to a frequently generated handoff between cells and to provide a structure more efficient for data transmission of an optical system for a traffic distribution, in proposing an optical distributed network system using an optical relay constructed by a plurality of unitary picocells employing multi input multi output (MIMO) for a B3G or 4^{th} generation mobile communication system.

In one embodiment, there is provided a system for communicating between a base station transceiver subsystem and radio access units in a wireless communication system in which a plurality of the radio access units connect to one base station transceiver subsystem, and the radio access units and the base station transceiver subsystem constitute one picocell, respectively. The system includes a data path switch for switching a signal received from a base station controller, to a predetermined picocell, a micro cell HD controller and a picocell HD controller for detecting header information of the signal received from the base station controller, and controlling the data path switch to switch to a predetermined micro cell to receive the signal, and the predetermined picocell provided within the predetermined micro cell, using the detected header information, a picocell power meter for receiving a signal strength from the mobile terminal provided within a service boundary of the predetermined picocell, and performing a power control, a modem for modulating, encoding, and transmitting the signal inputted from the data path switch, to an optical transceiver, and modulating, encoding, and transmitting a signal inputted from the optical transceiver, to the data path switch and an optical transceiving unit for receiving an electric signal from the modem, converting the received electric signal into an optical signal, and transmitting the optical signal, and receiving an optical signal, converting the received optical signal into an electric signal, and outputting the converted electric signal to the modem.

### BRIEF DESCRIPTION OF THE DRAWINGS

The above features and advantages of the present invention will become more apparent from the following detailed description when taken in conjunction with the accompanying drawings in which:

FIG. 1 illustrates a construction of a conventional distributed network system using an optical relay;

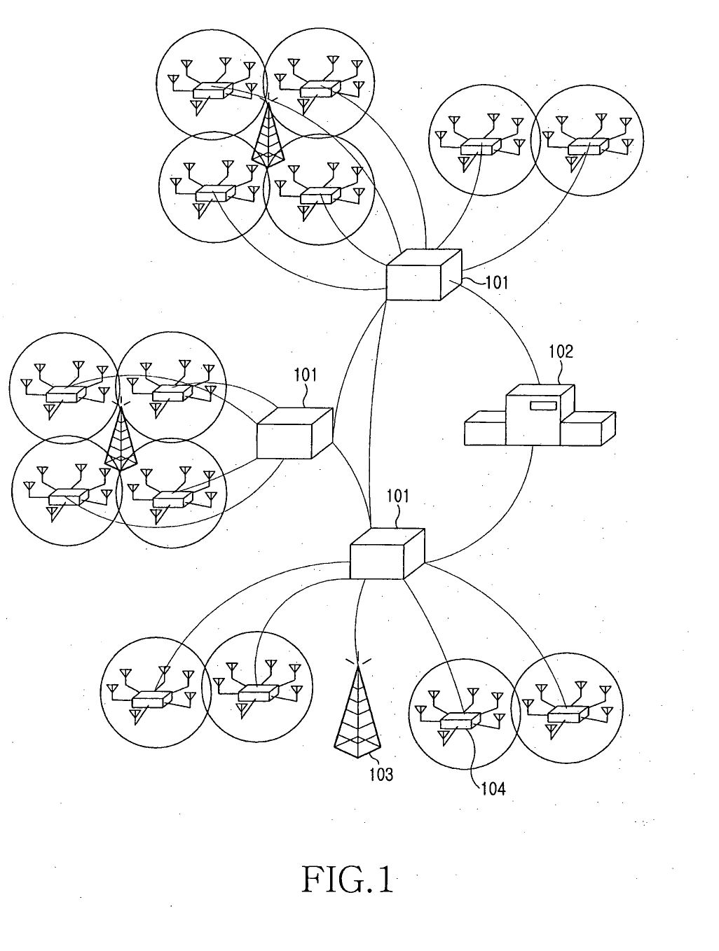

FIG. 2 illustrates a construction of an optical distributed network system using MIMO according to an exemplary embodiment of the present invention;

FIG. 3 illustrates an internal construction of a micro cell of FIG. 2;

FIG. 4 illustrates a construction of a distributed network controller according to an exemplary embodiment of the present invention;

FIG. 5 illustrates a construction of a radio access unit according to an exemplary embodiment of the present invention;

FIG. 6 illustrates an example of an on/off operation of a picocell by a signal according to an exemplary embodiment of the present invention.

### DETAILED DESCRIPTION

An embodiment of the present invention will now be described in detail with reference to the annexed drawings. In the drawings, the same or similar elements are denoted by the same reference numerals even though they are depicted in different drawings. For the purposes of clarity and simplicity, a detailed description of known functions and configurations incorporated herein has been omitted for conciseness.

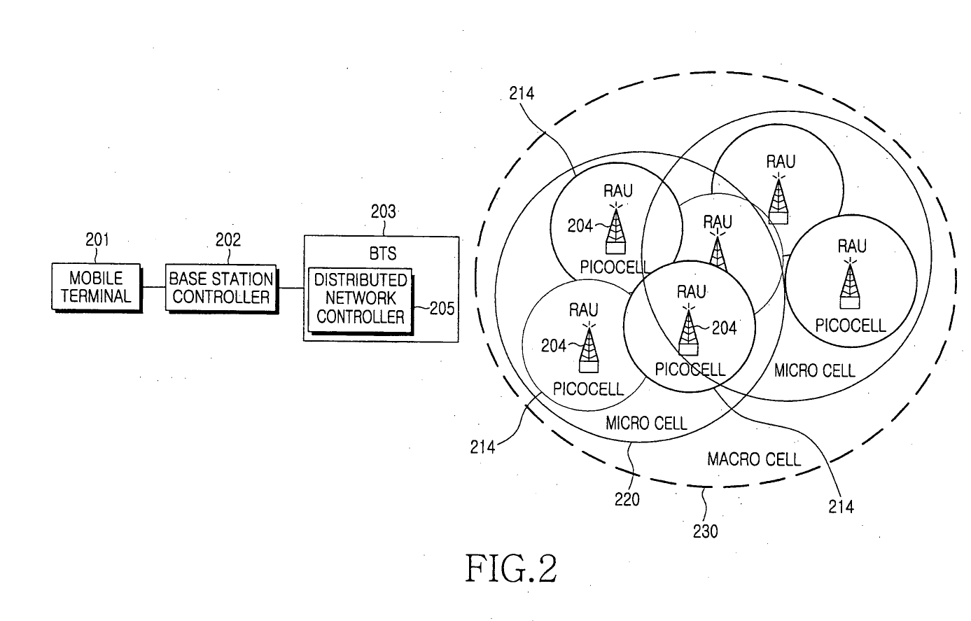

FIG. 2 illustrates a construction of an optical distributed network system using multi input multi output (MIMO) technology according to an exemplary embodiment of the present invention.

Referring to FIG. 2, the inventive optical distributed network system using the MIMO includes a mobile switching center (MSC) 201, a base station controller (BSC) 202, a base station transceiver subsystem 203 including a distributed network controller 205 and radio access units 204.

The optical distributed network system using the MIMO will be described in more detail below. The mobile switching center 201, a switching system widely used in a mobile communication system, performs a function of call connection depending on incoming and outgoing of a call. In a system aiming at a data communication in conformance with the 3^{rd} generation partnership project 2 (3GPP2) the mobile switching system is developing into a type in which it performs only a switching function among various functions. This is referred to as “MSCe”. The mobile switching center 201 refers to a device for performing the switching function for the call connection in a 2^{nd} or 3^{rd} generation mobile communication system. Including the switching function, the mobile switching center 201 should be interpreted as the same meaning even though it is commonly used by a different name in future systems.

The base station controller 202, controlling a plurality of base stations 103, refers to a device for a connection of a data call including a voice signal between the mobile switching center 201 and the base station transceiver subsystem 203. Thus, the base station controller 202 provides a communication path between the mobile switching center 201 and the base station transceiver subsystem 203, and controls radio resource allocation and scheduling of the base station transceiver subsystem 203. In general, these control functions are known to those having an ordinary knowledge in a wireless communication system art and thus, will not be described in more detail.

The base station transceiver subsystem 203 includes the distributed network controller 205, according to the present invention, and includes a plurality of radio transceivers (not shown in FIG. 2). Each of the radio transceivers, which are units for performing a voice or data communication with one wireless terminal, performs transmission/reception of data by a predetermined radio band set in the wireless communication system. The radio transceivers can include modems for modulating or demodulating, and encoding or decoding transmission/reception data. In the present invention, one base station transceiver subsystem 203 connects at its lower level with the plurality of radio access units (RAU) 204.

The inventive wireless communication system uses a high frequency band. Using the high frequency band, the wireless communication system has a feature of strong direct and weak diffraction when transmitting an electric wave. Accordingly, in order to provide a base station service boundary of the same range as that of the conventional art, the inventive wireless communication system guarantees a base station 103 service boundary as in the conventional art, using the radio access units 204 that manage a corresponding picocell. Thus, as shown in FIG. 2, picocell 214 has predetermined service boundaries around a corresponding radio access unit 204. These service boundaries are called “picocells” in the present invention. A micro cell 220 created by collecting a plurality of picocells 214. A macro cell 230 is formed by collecting at least two micro cells 220. Thus, the base station transceiver subsystem 203 can manage one macro cell 230 or manage one micro cell 220. That the base station transceiver subsystem 203 can manage cells of sizes different from each other, such as the micro cell 220 or the macro cell 230, is decided depending on the number of mobile terminals provided in a corresponding service boundary.

As the micro cell 220 is created by collecting several picocells 214, the number of the picocells 214 is cautiously decided considering conditions such as expected traffic circumstances and the number of users at a place where a system is to be installed. This is a fact obvious to those having an ordinary knowledge in the art. The MIMO, which is a key technology of a B3G or 4^{th} generation mobile communication system, is embodied on a per-picocell basis. The mobile terminal (not shown) can communicate with the radio access unit of a service boundary where it is positioned, using the MIMO.

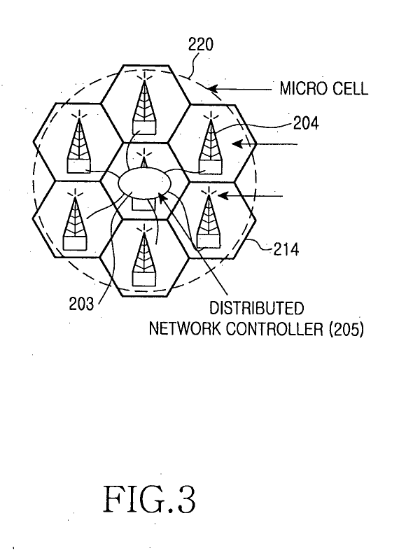

FIG. 3 illustrates an internal construction of the micro cell 220 of FIG. 2. The radio access unit will be typically denoted by a reference numeral 204 below.

Referring to FIG. 3, the base station transceiver subsystem 203 is positioned substantially in the middle of the micro cell 220 to minimize a distance from each radio access unit 204. The present invention provides the distributed network controller 205 within the base station transceiver subsystem 203 to manage the plurality of radio access units 204.

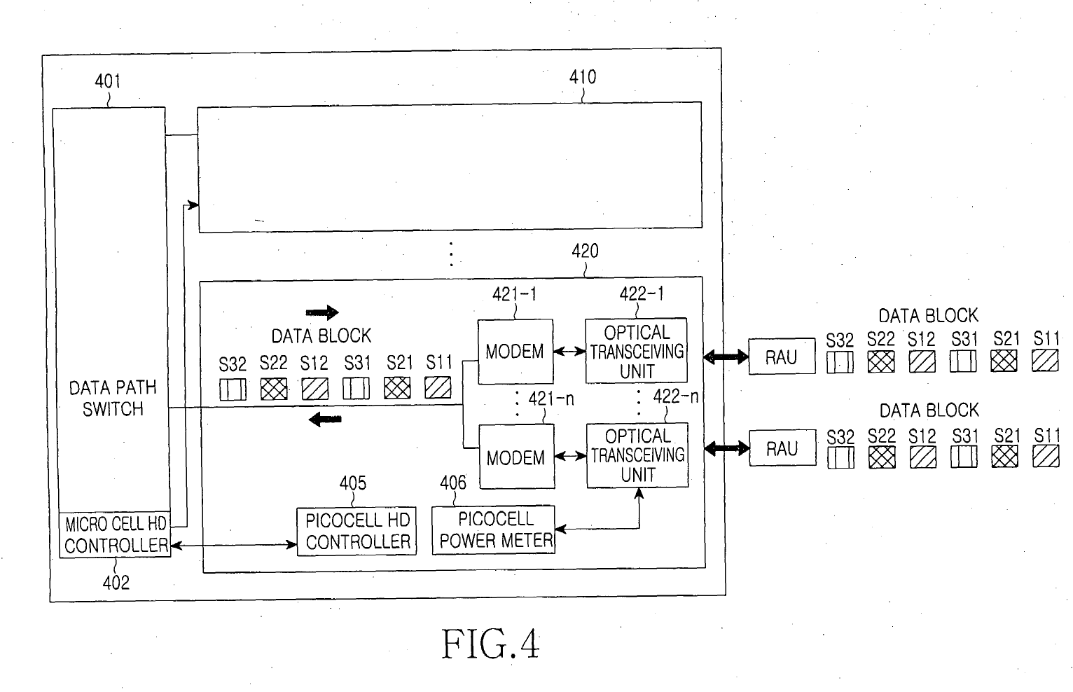

The distributed network controller 205 will be in more detail described in FIG. 4. As shown in FIG. 3, the base station transceiver subsystem 203 can also be one of the picocells.

Thus, the base station transceiver subsystem 203 has to have the same construction as the radio access unit 204. In other words, in the present invention, the radio access units 204 all included within one base station 103 in a conventional system are constructed using the picocells 214. Connection between the base station transceiver subsystem 203 and the radio access units 204 constituting the respective picocells 214 uses an optical communication method. The present invention proposes that a communication between the base station transceiver subsystem 203 and the radio access unit 204 be based on a baseband optical communication.

In addition, a signal strength of the mobile terminal in the picocells 214 is normalized in the radio access unit 204, and is concurrently transmitted as an analog signal to the distributed network controller 205 over a separate optical channel. This is to remove a decoding and frame decapsulation time, thereby making a faster handoff possible.

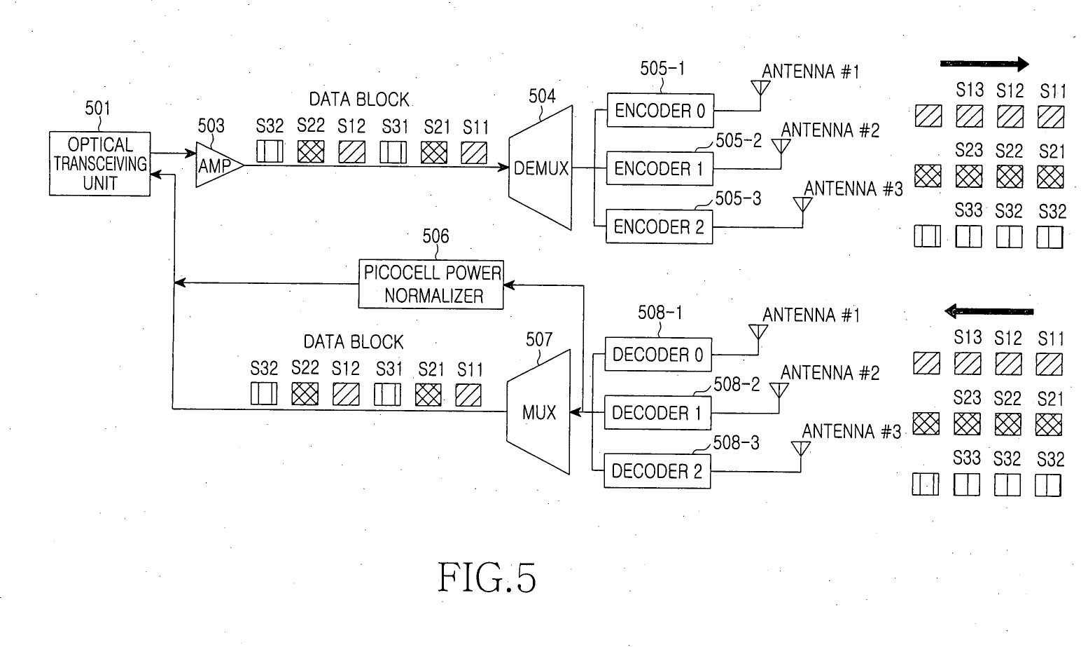

A communication process implemented in the inventive optical distributed network system is described with reference to FIGS. 4 and 5

The respective radio access units 204, which are installed within the picocells 214 within the micro cell 220, perform a communication between an uplink and a downlink transmission within the unitary micro cell 220, using the same frequency and the same channel, as follows.

Employed is a method in which data transmitted to the downlink is broadcasted and data transmitted to the uplink is unicasted. In other words, the data transmitted to the downlink employs a method in which, by broadcasting data to each mobile terminal, all terminals can receive the transmission but honor only their own data. On contrary, the data transmitted in the uplink employs a unicasting method so that a specific mobile terminal can distinguish a transmission signal. This is to prevent a consumption of excessive frequency channels. Distinguishing the uplink data on a per-user basis can secure a user channel by a multiplexing method such as orthogonal frequency division multiplexing (OFDM).

When the mobile terminal moves or changes position within the unitary micro cell 220, a change among the picocells 214 can be generated. The mobile terminal can implement a handoff between two picocells 214 in a soft handoff manner that swaps data between sectors or the picocells 214 is performed by a rake receiver. The soft handoff refers to a soft handoff implemented between the sectors included in a specific picocell. In other words, it is distinguished from a soft handoff implemented between the picocells 214. The handoff between the picocells 214 uses a normalized value of the strength of a signal received from the base station 103, in the mobile terminal. The distributed network controller 205 controls the handoff between the picocells 214, using this normalized value.

FIG. 4 illustrates a construction of a distributed network controller according to an exemplary embodiment of the present invention. The picocell will be typically denoted by a reference numeral 214 below.

Referring to FIG. 4, the inventive distributed network controller includes a data path switch 401, a micro cell HD controller 402, a picocell HD controller 405, a picocell power meter 406, modems 421-1, . . . , 421-n, and optical transceiving units 422-1, . . . , 422-n.

The data path switch 401 switches to the picocell 214 depending on whether the distributed network controller 205 transmits a signal received from an upper level, to any picocell 214. Here, the upper level refers to the base station controller 202 or its corresponding node for the call connection, and the picocell 214 includes a cell where the base station transceiver subsystem 203 is positioned.

The micro cell HD controller 402 detects whether the distributed network controller 205 transmits the reception signal from the upper level to any micro cell 220, using a header, which controls the data path switch 401 to switch to the detected micro cell 220.

The picocell HD controller 405 detects whether the distributed network controller 205 transmits the signal to any picocell 214 of the micro cell 220 detected by the micro cell HD controller 402, using a header, which controls the data path switch 401 to switch to the detected picocell 214.

The picocell power meter 406 receives the signal strength “s” from the radio access unit 204 of the picocell 214 by the respective mobile terminals provided within the service boundary of the picocell 214 and uses the received signal strength s for power control and future scheduling.

Depending on a method adopted by the B3G or 4G mobile communication system, the modems 421-1, . . . , 421-n modulate and encode data for transmission, and demodulate and decode received signals. Examples of modulation methods are binary PSK (BPSK), quadrature phase shift keying (QPSK), 16-quadrature amplitude modulation (16-QAM), and 64-quadrature amplitude modulation (64-QAM) methods. A 16-QAM or more modulation method can be employed for higher data rate. Further, a modulation method having a higher order than the 64-QAM method can be employed. An encoding and decoding method can employ a convolution code method, a turbo code method, a quasi-complementary turbo code (QCTC) method, or a low density parity check (LDPC) encoding method. For the higher data rate, it will be most effective to employ the LDPC method, the turbo code method, or the quasi-complementary code method.

The optical transceiving units 422-1, . . . , 422-n refer to devices for performing an optical communication with the radio access unit 204. The optical transceiving units 422-1, . . . , 422-n receive electric signals from respective modems 421-1, . . . , 421-n, convert the received signals into optical signals, and transmit the converted signals. The optical transceiving units 422-1, . . . , 422-n receive optical signals from the radio access unit 204, convert the received optical signals into electric signals, and outputs the converted signals to the modems 421-1, . . . , 421-n. The radio access unit 204 will be described with reference to FIG. 5 later.

As shown in FIG. 4, the distributed network controller 205 includes the data path switch 401 for enabling data swap between the micro cells 220. The data path switch 401 can be constituted as a logical switch.

The present invention proposes the switch between the micro cells 220 to adapt the downlink data transmitted from the distributed network controller 205, to a distributed network, and transmit the adapted data to a relevant picocell 214. Such a switching system refers to an input/output system corresponding to one picocell 214 (or radio access unit 204).

The switching system has a structure in which data to be inputted to and outputted from each picocell can be handled using data paths of the same number as the number of antennas of a MIMO-blast system to be installed in the radio access unit 204. It can be used for a handoff function between the micro cells 220.

FIG. 5 illustrates a construction of the radio access unit according to an exemplary embodiment of the present invention.

Referring to FIG. 5, an optical transceiving unit 501 has the same construction as the optical transceiving units 422-1, . . . , 422-n of FIG. 4 and thus, its detailed description will be omitted.

An amplifier 503 amplifies a reception signal into a processable level signal, and outputs the amplified signal to a demultiplexer (DEMUX) 504. Thus, the demultiplexer 504 divides data to transmit on a per-antenna basis in order to transmit the data by the MIMO, and outputs the divided data to encoders 505-1, . . . , 505-3 associated with respective antennas. FIG. 5 exemplifies a case where three multi-antennas are used by the MIMO. However, in actuality, any number of multi-antennas may be used. Accordingly, two, three, four or more multi-antennas can be used depending on the MIMO used for the wireless communication system.

The encoders encode each received data suitably to the channel characteristics, and then transmit the encoded data through the antennas. It should be noted that a construction for wireless processing between the encoders 505-1, . . . , 505-3 and the antennas is known in the art and thus, is not shown in or described with regard to FIG. 5.

The antennas receive the signals from the mobile terminals, respectively, and output the received signals to decoders 508-1, . . . , 508-3. A construction of wireless processing for converting a wireless signal into a baseband signal is known in the art and thus, is not discussed. The respective decoders 508-1, . . . , 508-3 decode the signals encoded and transmitted by the mobile terminal. The respective decoders 508-1, . . . , 508-3 output the decoded signals to a multiplexer (MUX) 507 and a picocell power normalizer 506. The signal inputted to the multiplexer 507 is a data signal. The signal inputted to the picocell power normalizer 506 is information on a power level, which is received from the base station 103, measured, and fedback by each mobile terminal. The power level measured by the mobile terminal is normalized in the picocell power normalizer 506 and is provided to the base station transceiving subsystem 203 as described in FIG. 4. The signal normalized in the picocell power normalizer 506 is transmitted using a baseband transmission method as described above.

Transmission is identically performed using the baseband transmission method in multiplexer 507. The multiplexer 507 converts the signals received from the respective decoders 508-1, . . . , 508-3, into one data stream.

The MIMO used in the present invention can employ a plurality (N) of antennas, and can employ a blast method. Accordingly, the distributed network controller 205 can have N data paths for one terminal. However, the signal strength from the mobile terminal is normalized for distance, an optical attenuation, and each characteristic of the optical transceiving unit 501 so that a fast L1 handoff can be implemented between the picocells 214. This operation is possible when the mobile terminal initially registers to the wireless communication system, and has to be linked with a power control operation within the micro cell 220 so that a normalization value can be outputted. This signal is transmitted to the distributed network controller 205 of the base station transceiver subsystem 203 through an optical cable over a channel separate from a data communication.

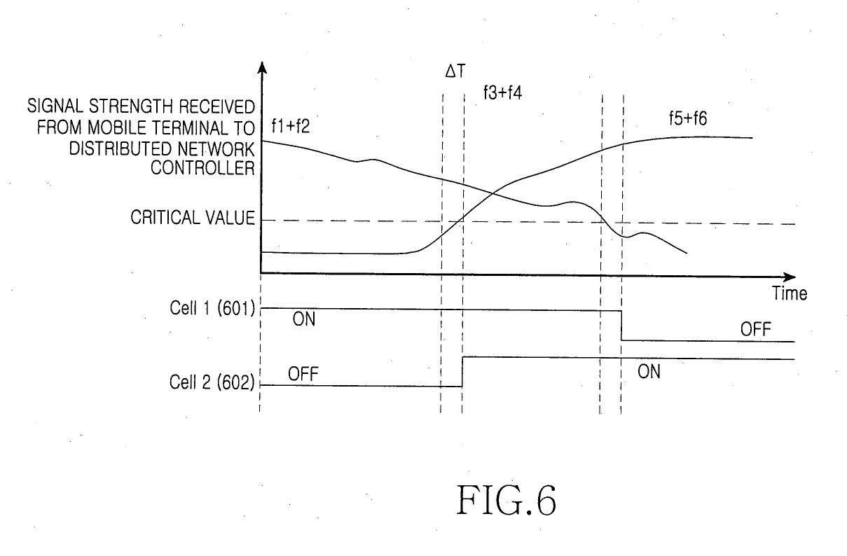

FIG. 6 illustrates an example of an on/off operation of the picocell by a signal according to an exemplary embodiment of the present invention.

Referring to FIG. 6, the base station transceiving subsystem 203 constructs a system for switching data when the handoff is implemented on a per-micro cell basis as described above. The data path based on the MIMO can be provided as much as the N antennas set to the radio access unit.

When the signal strength received from the mobile terminal to the distributed network controller 205 reduces to a preset critical value or less, and a time of “ΔT lapses, a cell 1 601 turns off. When the signal strength received from the mobile terminal to the distributed network controller 205 increases to the preset critical value or more, and the time of “ΔT lapses, a cell 2 602 turns off.

As described above, the present invention provides a structure corresponding to the generated handoff between the cells and a structure efficient for data transmission of an optical system for a traffic distribution, in proposing the optical distributed network system using the optical relay constructed by the plurality of unitary picocells employing the MIMO

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A system for communicating between a base station transceiver subsystem and radio access units in a wireless communication system in which a plurality of the radio access units connects to one base station transceiver subsystem, and the radio access units and the base station transceiver subsystem constitute a picocell, respectively, the system comprising:
a data path switch for switching a signal received from a base station controller, to a predetermined picocell within a plurality of picocells;
a micro cell HD controller and a picocell HD controller for detecting header information of the signal received from the base station controller, and controlling the data path switch to switch to a predetermined micro cell to receive the signal, and the predetermined picocell provided within the predetermined micro cell, using the detected header information;
a picocell power meter for receiving a signal strength from the mobile terminal provided within a service boundary of the predetermined picocell, and performing a power control;
a modem for modulating, encoding, and transmitting the signal inputted from the data path switch, to an optical transceiver, and modulating, encoding, and transmitting a signal inputted from the optical transceiver, to the data path switch; and
an optical transceiving unit for receiving an electric signal from the modem, converting the received electric signal into an optical signal, and transmitting the optical signal to the radio access unit, and receiving an optical signal from the radio access unit, converting the received optical signal into an electric signal, and outputting the electric signal to the modem.

2. The system of claim 1, wherein the base station transceiving subsystem and the radio access unit transceive data by MIMO (multi input multi output).

3. The system of claim 2, wherein the radio access unit comprises:
an optical transceiving unit for transmitting an optical signal received from the base station transceiver subsystem, to an amplifier;
the amplifier for receiving the optical signal from the optical transceiving unit, amplifying the received optical signal into a processable level signal, and transmitting the amplified processable level signal to a demultiplexer;
the demultiplexer for receiving the amplified processable level signal from the amplifier, and outputting the received signal to encoders associated with antennas, respectively, by the MIMO;
the encoder for wirelessly processing the signal received from the demultiplexer, and outputting the signal to the mobile terminal using the antenna;
the decoder for receiving the signal encoded and transmitted by the mobile terminal, using the antenna, decoding the received signal, and outputting the decoded signal to a multiplexer and a picocell power normalizer;
the picocell power normalizer for receiving from the decoder information on a power level, which is measured and fedback by the mobile terminal, of a signal received from a base station, and normalizing the received information; and
the multiplexer for converting the signal received from the decoder, into a data stream, and transmitting the data stream to the optical transceiver.

4. The system of claim 1, wherein the radio access unit performs a communication between an uplink and a downlink within the unitary micro cell, using the same frequency and the same channel, and data transmitted to the downlink is broadcasted, and data transmitted to the uplink employs a unicasting method based on a multiplexing method such as OFDM (orthogonal frequency division multiplexing) so that a user channel is secured.

5. The system of claim 4, wherein, when the picocell is changed within the unitary micro cell, the mobile terminal performs a handoff between the picocells in a soft handoff manner that data swap between sectors or the picocells is performed by a rake receiver.

6. The system of claim 1, wherein the radio access unit communicates with the base station transceiver subsystem by a baseband optical communication.

7. The system of claim 1, wherein the signal strength of the mobile terminal in the picocell is normalized in the radio access unit, and is concurrently transmitted as an analog signal to the distributed network controller over a separate optical channel so that a decoding and frame decapsulation time is removed and a faster handoff is made possible.

8. The system of claim 7, wherein data is switched between the micro cells so that it is adapted to a distributed network in order to transmit downlink data transmitted from the distributed network controller, to a relevant picocell.
